(19) United States
(12) Patent Application Publication
(10) Pub. No.: US 2013/0068769 A1
(43) Pub. Date: Mar. 21, 2013

(54) LIDDING STRUCTURE BASED ON POLYLACTIC ACID FILM

(71) Applicants: Gordon Vincent SHARPS, North Kingstown, RI (US); Roberto SIU, Providence, RI (US)

(72) Inventors: Gordon Vincent SHARPS, North Kingstown, RI (US); Roberto SIU, Providence, RI (US)

(73) Assignee: TORAY PLASTICS (AMERICA), INC., N. Kingstown, RI (US)

(21) Appl. No.: 13/535,270

(22) Filed: Jun. 27, 2012

Related U.S. Application Data
(60) Provisional application No. 61/536,854, filed on Sep. 20, 2011.
(60) Provisional application No. 61/535,607, filed on Sep. 16, 2011.

(51) Int. Cl. B65D 53/00; B32B 27/08; B05D 5/10; C09J 7/02

(52) U.S. Cl. 220/378; 428/349; 428/325; 428/327; 428/335; 428/337; 427/208.2

(57) ABSTRACT

Described is a multi-layer film suitable as sealable or peelable sheet specially used for closing foodstuff containers. This multi-layer sheet includes a polymeric substrate layer and a seal or a peel-seal layer. Preferably, the film includes at least three main component layers, namely in order, a polymeric base layer for mechanical strength, an ethylene polymer-based adhesive layer, and a heat seal layer comprising an ethylene copolymer, such as ethylene vinyl acetate copolymer.

### CROSS-REFERENCE TO RELATED APPLICATION

This application claims the benefit of U.S. Provisional Application Ser. No. 61/536,854, filed Sep. 20, 2011, and U.S. Provisional Application Ser. No. 61/535,607, filed Sep. 16, 2011, the entire contents of which is incorporated herein by reference.

### FIELD OF THE INVENTION

This invention relates to a film for peelable container lids and a method of making such film. More specifically, it relates to a composite film including a polylactic acid film coated with a peelable seal layer suitable for container lids.

### BACKGROUND OF THE INVENTION

Most seal or adhesive peel-seal layers are formed by very thin lacquer layers having a thickness of only few μm, typically below 20 μm, more typically below 10 μm. These thin seal or peel-seal layers are used in the drug and foodstuff packaging industries. However, these layers have drawbacks, which include that these lacquer layers are formed using an organic solvent which is eliminated in-line after applying the lacquer onto a substrate layer. The elimination of the organic solvents in a dryer is time consuming. This means that if high production speeds are desired, an in-line coating process may require a very large plant. Higher production speeds is a general trend of the packaging industry. Accordingly, longer dryers are used in order to limit the amount of residual solvent in the seal or peel-seal layer below the legal requirements. Moreover, the recovery of the organic solvent is also expensive.

In addition, most conventional lidding films include at least two component layers. First a base layer forms a mechanical closure preventing foreign substances from entering the container. Second a seal layer which most commonly is thermally adhered to the circumference of the container mouth provides a seal removable by peeling, preferably without tearing or leaving sealant material on the container. Many sophisticated modifications and additions to these basic components have developed to provide advantageous features to peelably lidded containers.

A particular disadvantage of many peelable-lidded containers is that the adhesion of the lidding film to the container is so strong that the film is difficult to remove from the container. Additionally, the strong adhesion can undesirably wholly or partially delaminate the lidding film leaving pieces of the film adhered to the lip of the container mouth. However, if the adhesion to the container mouth is made too weak, the lidding film can be removed inadvertently or prematurely by many incidental causes including, for example, pressure and movement of the contained material.

U.S. Pat. No. 6,616,998 and U.S. Pat. No. 5,888,599 disclose exemplary conventional peelable, sealable films used for lidding and packaging foods. These films are prepared using multi-step processes in which a core film is first prepared. This core film forms a base layer that is then coated with a hot melt adhesive in a separate step to form a skin layer, whose function is to provide a peelable heat seal.

In addition, other sealable films known in the art are coextruded. While these coextruded films are cost-effective to produce, the obtained films are not truly peelable as they often tear and split when removed from the package, often sticking to the food, especially to foods that contain sauces and cheese such as pizza.

### SUMMARY OF THE INVENTION

Described are multilayer films for peelable container lids and a method of making such film. More specifically, it relates to a composite film including a polylactic acid film coated with a peelable seal layer suitable for container lids.

Embodiments of a multilayer film may include a polymeric base layer, an adhesive layer including an ethylene based polymer on a surface of the base layer, and a heat seal layer including an ethylene copolymer on a surface of the adhesive layer. The base layer may include polylactic acid, polypropylene, polyester, or polyamide. The base layer may include amorphous silica, calcium carbonate, clay, talc, diatomaceous earth, cross-linked spherical polymers, or glass beads. In some embodiments, the base layer may be 5 to 75 microns in thickness.

In some embodiments, the multilayer film of claim 1, wherein the adhesive layer is 1 to 35 microns in thickness. The adhesive layer may include at least 50 wt % ethylene based polymer.

In some embodiments, the heat seal layer may be electrostatically treated at a watt density 0.5 to 5 watts/square feet/min. The heat seal layer may include an ethylene copolymer of vinylacetate, methylacrylate, ethylacrylate or butylacrylate. The heat seal layer may include ethylene vinylacetate copolymer. The heat seal layer may include diatomaceous earth or silica. The heat seal layer may include a fatty amide. The heat seal layer may have a seal strength to itself of between 300 gm/in to 3,000 gm/in based on sealing at 375° F., 30 psia, and 0.5 seconds dwell. In some embodiments, the heat seal layer may be 12 to 75 microns in thickness.

Embodiments of methods of making a multilayer film may include providing a polymeric base layer, applying an adhesion layer comprising polyethylene on a surface of the base layer, and applying a heat seal layer on a surface of the adhesion layer, the heat seal layer comprising a thermoplastically adhesive ethylene polymer. In some embodiments, the adhesion layer and heat seal layer are coextruded with the polymeric base layer. Alternatively, the adhesion layer and heat seal layer may be applied by extrusion coating. The polymeric base layer may be uniaxally or biaxally oriented.

Embodiments of a container may include a container body including a lid sealant surface of a polymeric composition, and a lid including a multilayer film including a polymeric base layer, an adhesion layer including an oxidized polyethylene; and a heat seal layer comprising a thermoplastically adhesive ethylene polymer.

### DETAILED DESCRIPTION OF THE INVENTION

Described are multilayer composite films that may include at least three component layers, preferably in the following order, a polymeric base layer for mechanical strength, an ethylene polymer-based adhesive layer, and a heat seal layer including an ethylene copolymer, such as ethylene vinylacetate copolymer. The heat seal layer can be applied by extrusion coating with or subsequent to the application of the adhesive layer. Care, however, may be taken to prevent excessive heating that can degrade the heat seal polymer.

Some embodiments of a multilayer film include (A) a polymeric base layer, (B) an adhesion layer including polyethylene and (C) a heat seal layer including a thermoplastically adhesive ethylene polymer selected from ethylene vinyl acetate copolymer (EVA copolymer) and blends of EVA copolymer with polyethylene. The adhesion layer (B) is a tie-layer between the base layer (A) and the heat seal layer (C). The total thickness of layer (A), (B), and (C) are preferably between 10-300 microns, more preferably between 20-200 microns.

The base layer preferably includes or consists of at least one film layer that includes or consists of polylactic acid, polypropylene, polyester, and polyamide. The base layer may include or consist of other similar polymeric films.

In some embodiments, the base layer may include a thermoplastic polymer film such as polylactic acid, semi-crystalline homopolymer polyethylene terephthalate or amorphous polyethylene terephthalate copolymer, polypropylene, or polyamide. The base layer may optionally be modified by the addition of organic or inorganic particulates such as amorphous silica, calcium carbonate, clay, talc, diatomaceous earth, cross-linked spherical polymers such as poly(dimethylsiloxane) or others, glass beads or mixtures of two or more of the above to facilitate winding and handling of the film, or to enhance the mechanical and optical properties of the film, including reduction of the density of the film via cavitation. Furthermore a regrind of the film or of any other compatible film or resin may be included in the base layer to reduce material costs. This layer's thickness is preferably between 5 microns and 75 microns, more preferably between 10 and 60 microns, and more preferably between 12 and 50 microns.

A second layer, underneath the seal layer, is provided to enhance adhesion between the seal layer and the remaining layers. This second layer may include ethylene compounds that create bonding between the base layer and the sealant layer. Such polyethylene copolymers may contain additional comonomers to affect such properties as melting and softening point, viscosity or cross-linking etc. This layer's thickness is preferably between 1 micron and 35 microns, more preferably between 1 and 20 microns, and more preferably between 1 and 10 microns.

Preferably the adhesive layer is made up of greater than 50 wt % ethylene-based polymer which can be, for example, an ethylene homopolymer or copolymer or blend thereof. More preferably, the adhesive layer includes more than 75 wt %. More preferably, the adhesive layer includes more than 80 wt %. If a copolymer, the comonomer content is preferably a minor fraction. The comonomer is preferably a carboxylic acid-containing moiety, such as for example, methacrylic acid and acrylic acid. Effective adhesion of the multilayer film composite layers can be achieved by thermally activated reaction of primarily carboxylic acid functional groups of the adhesive layer polymer with the primer. A mechanism for generating reactive carboxylic acid functional groups is oxidizing the ethylene of the adhesive layer. Preferably the extrudate should be in the range of about 249° C.-335° C. (480° F.-635° F.) for oxidation of polymeric ethylene to occur.

The heat seal layer provides the film with the ability to be heat-sealed to itself or to other films, sheets, or trays made from crystallized polyethylene terephthalate (CPET), amorphous polyethylene terephthalate (APET), foil, PET-coated paperboard, PVC, glass, polypropylenes or polyethylenes, polylactic acid, polystyrenes (PS), or other polyolefins at temperatures ranging from 50 to 200° C. The heat seal layer can be formulated to provide either a film destruct bond, or preferably a peelable bond to the other material. The preferred seal range for this layer (to itself or to other substrates) is between 300 gm/in to 3,000 gm/in (based on sealing at 375 degrees F., 30 psia, 0.5 seconds dwell). Said layer is preferably formulated to allow direct contact with food under storage either frozen, refrigerated or at room temperature or when heating or cooking in a microwave or in a conventional oven. The heat seal layer is preferably formulated to prevent food from sticking to the film. This layer's thickness is preferably between 12 microns and 75 microns, more preferably between 12 and 60 microns, more preferably between 12 and 50 microns.

The polyolefin forming the seal layer preferably includes an ethylene copolymer of at least one of vinylacetate, methylacrylate, ethylacrylate and butylacrylate. These polymers can be, for example, ethylene copolymers with vinyl acetate EVA, acrylics such as methyl acrylate EMA, combinations of methyl acrylate and acrylic acid EMAAA, butyl acrylate EBA, both methyl acrylate and methacrylic acid EMAMAA, butyl acrylate and acrylic acid EBAAA. These acrylics and their blends with or without polyethylene have a degradation temperature limit, usually over 500° F., above which the thermoplastically adhesive ethylene polymer reacts resulting in a tacky material that for smooth coatings results in film blocking or high friction or results in cross-linking that creates melt extrusion gels or plugging.

Diatomaceous earth or silica may be added to the seal layer, for example, in the amount of 1,000 parts per million (ppm) to 10,000 ppm to add microscopic surface roughness which prevents sticking or “blocking” when the co-extruded blend side is wound against the opposite side in a roll. Fatty amides such as oleamide or erucamide may be added to modify the coefficient of friction of the seal layer. The amount added is dependent on the coefficient of friction desired, the co-extrusion structure, lamination structure and co-extrusion thickness. In general, a preferable amount of fatty amide is 100 ppm to 2000 ppm. More preferably between 250 ppm to 2000 ppm. More preferably between 500 ppm to 2000 ppm.

Preferably, the multilayer-sheet is prepared by extrusion or coextrusion coating. The multilayer sheet may also be prepared by providing a polymeric base layer, which is produced beforehand by biaxially orienting the polymer. The multilayer film is then extrusion coated with an adhesion layer including polyethylene, followed by a sealant composition including a thermoplastically adhesive ethylene polymer selected from ethylene vinyl acetate copolymer (EVA copolymer) and blends of EVA copolymer with polyethylene on the adhesion layer.

In some embodiments, the extrusion coated heat seal layer can be modified by electrostatic treatment to provide specific seal properties such as higher seal strength and peelable performance to specific substrates such as crystalline polyester trays and polylactic acid trays. The desired applied watt density for this layer could be in the range of about 0.5 to 5 (watts/square feet/min). More preferably in the range of 0.5 to 4 watts/square feet/min, more preferably in the range of 0.5 to 3 watts/square feet/min.

The seal layer may include additional additives to improve non sealing properties of the sealing layer. Examples of some of the properties which can be modified are coefficient of friction, resistance to blocking, UV stability, thermal stability and color. The described multilayer film may provide a lidding for closing a container, the lidding including a substrate, a tie layer and a heat seal layer of extruded sealant, the sealant being capable of providing a seal for the container to which the lidding is heat sealed and easy peelability by adhesive failure between said sealant and said container so as to leave said container free of sealant. The sealant blend preferably has sufficient compatibility so as to have a greater cohesive strength than the peel strength of the seal between the sealant and the container. Preferably, the blend of the sealant is capable of providing a seal with the container that exhibits a peel strength that varies with seal temperature in the range of 1 to 5 pounds force per inch, more preferably in the range of 1 to 4 pounds force per inch, more preferably in the range of 1 to 3 pounds force per inch all ranges measured at 135° C., 30 pounds per square inch pressure and 0.5 seconds dwell. Preferred heat seal temperatures range from 90° C. to 200° C., more preferably between 95° C. to 180° C., more preferably between 100° C. and 175° C.

Yet embodiments are a container including a container body having a lid sealant surface of a polymeric composition, and a lid including a multilayer film including (A) a polymeric base layer, (B) an adhesion layer including oxidized polyethylene, and (C) a heat seal layer including a thermoplastically adhesive ethylene polymer selected from the group consisting of ethylene copolymers with vinyl acetate (EVA), or acrylics and methacrylics such as methyl acrylate (EMA), butyl acrylate (EBA), methacrylic acid (EMAA), mixed copolymers and their blends with or without polyethylene.

This invention will be better understood with reference to the following examples, which are intended to illustrate specific embodiments within the overall scope of the invention.

### Example 1

A polylactic acid film with a thickness of 0.8 mils was made of a polylactic acid resin made from Natureworks Ingeo 4032D grade, such film having the trademark PLA3 from Toray Plastics America. The polylactic acid film exhibits at least one crystallization peak at 110° C. when cooled at 20° C./min from a molten state in a differential scanning calorimeter. The film was extrusion coated with an adhesive layer made of an ethylene compound at three pounds per ream, followed by a heat seal layer made of an ethylene copolymer of vinylacetate at eight pounds per ream.

### Example 2

A biaxially oriented polyester film was made with a thickness of 0.48 mils, such film having the tradename Lumirror PA10 by Toray Plastics America and having a Young's modulus of 700,000 lb/square inch, this film was extrusion coated with an adhesive layer made of an ethylene compound at three pounds per ream, followed by a heat seal layer made of an ethylene copolymer of vinylacetate at eight pounds per ream.

### Example 3

A biaxially oriented polypropylene film was made with a thickness of 1.2 mils, such film having the trademark TREA DR22 from Toray Plastics America. It was extrusion coated with an adhesive layer made of an ethylene compound at three pounds per ream, followed by a heat seal layer made of an ethylene copolymer of vinylacétate at eight pounds per ream.

### Example 4

A biaxially oriented heat sealable polyester film was made with a thickness of 0.6 mils, such film having the trademark PA25 from Toray Plastics America and having a Young's modulus of 750,000 lb/square inch and an amorphous polyester adhesion layer.

TABLE 1

| Example 1 | Example 2 | Example 3 | Example 4 |
|---|---|---|---|
| 80 ga PLA3 | 48 ga PA10 | 1.2 mils DR22 | 60 ga PA25 |
| from Toray | from Toray | OPP Toray | Toray |
| Plastics with | Plastics with | Plastics with | Plastics heat |
| EVA heat | EVA heat | EVA heat | sealable |
| seal layer | seal layer | seal layer | PET |

| | | | | |
|---|---|---|---|---|
| Heat Seal | 2.29 lbf/ | 1.8 lbf/ | 1.24 lbf/ | 2.16 lbf/ |
| strength to rigid | in @ | in @ | in @ | in @ |
| CPET tray 30 psi | 250 F. | 375 F. | 250 F. | 275 F. |
| and 0.5 sec dwell | | | | |

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges. The above description is presented to enable a person skilled in the art to make and use the invention, and is provided in the context of a particular application and its requirements.

Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

1. A multilayer film comprising:
a polymeric base layer;
an adhesive layer comprising an ethylene based polymer on a surface of the base layer; and
a heat seal layer comprising an ethylene copolymer on a surface of the adhesive layer.

2. The multilayer film of claim 1, wherein the base layer comprises polylactic acid, polypropylene, polyester, or polyamide.

3. The multilayer film of claim 1, wherein the base layer comprises amorphous silica, calcium carbonate, clay, talc, diatomaceous earth, cross-linked spherical polymers, or glass beads.

4. The multilayer film of claim 1, wherein the base layer is 5 to 75 microns in thickness.

5. The multilayer film of claim 1, wherein the adhesive layer is 1 to 35 microns in thickness.

6. The multilayer film of claim 1, wherein the adhesive layer comprises at least 50 wt % ethylene based polymer.

7. The multilayer film of claim 1, wherein the heat seal layer is electrostatically treated at a watt density 0.5 to 5 watts/square feet/min.

8. The multilayer film of claim 1, wherein the heat seal layer comprises an ethylene copolymer of vinylacetate, methylacrylate, ethylacrylate or butylacrylate.

9. The multilayer film of claim 1, wherein the heat seal layer comprises ethylene vinylacetate copolymer.

10. The multilayer film of claim 1, wherein the heat seal layer comprises diatomaceous earth or silica.

11. The multilayer film of claim 1, wherein the heat seal layer comprise a fatty amide.

12. The multilayer film of claim 1, wherein the heat seal layer has a seal strength to itself of between 300 gm/in to 3,000 gm/in based on sealing at 375° F., 30 psia, and 0.5 seconds dwell.

13. The multilayer film of claim 1, wherein the heat seal layer is 12 to 75 microns in thickness.

14. A method of making a multilayer film comprising:
providing a polymeric base layer;
applying an adhesion layer comprising polyethylene on a surface of the base layer; and
applying a heat seal layer on a surface of the adhesion layer, the heat seal layer comprising a thermoplastically adhesive ethylene polymer.

15. The method of claim 14, wherein the adhesion layer and heat seal layer are coextruded with the polymeric base layer.

16. The method of claim 14, wherein the adhesion layer and heat seal layer are applied by extrusion coating.

17. The method of claim 14, further comprising biaxially orienting the polymeric base layer.

18. The method of claim 14, wherein the polymeric base layer comprises polylactic acid, polypropylene, polyester, or polyamide.

19. The method of claim 14, wherein the polymeric base layer comprises amorphous silica, calcium carbonate, clay, talc, diatomaceous earth, cross-linked spherical polymers, or glass beads.

20. The method of claim 14, wherein the polymeric base layer is 5 to 75 microns in thickness.

21. The method of claim 14, wherein the adhesion layer is 1 to 35 microns in thickness.

22. The method of claim 14, wherein the adhesion layer comprises at least 50 wt % ethylene based polymer.

23. The method of claim 14, further comprising electrostatically treating the heat seal layer at a watt density 0.5 to 5 watts/square feet/min.

24. The method of claim 14, wherein the heat seal layer comprises an ethylene copolymer of vinylacetate, methylacrylate, ethylacrylate or butylacrylate.

25. The method of claim 14, wherein the heat seal layer comprises ethylene vinylacetate copolymer.

26. The method of claim 14, wherein the heat seal layer comprises diatomaceous earth or silica.

27. The method of claim 14, wherein the heat seal layer comprise a fatty amide.

28. The method of claim 14, wherein the heat seal layer has a seal strength to itself of between 300 gm/in to 3,000 gm/in based on sealing at 375° F., 30 psia, and 0.5 seconds dwell.

29. The method of claim 14, wherein the heat seal layer is 12 to 75 microns in thickness.

30. A container comprising:
a container body comprising a lid sealant surface of a polymeric composition; and
a lid comprising a multilayer film comprising:
a polymeric base layer,
an adhesion layer comprising an oxidized polyethylene; and
a heat seal layer comprising a thermoplastically adhesive ethylene polymer.
